(19) United States
(12) Patent Application Publication
(10) Pub. No.: US 2010/0060808 A1
(43) Pub. Date: Mar. 11, 2010

(54) DIGITAL IMAGE DISPLAY DEVICE

(75) Inventor: Christine Caubel, Paris (FR)

Correspondence Address: HAVERSTOCK & OWENS LLP, 162 N WOLFE ROAD, SUNNYVALE, CA, 94086, US

(73) Assignee: PARROT, Paris (FR)

(21) Appl. No.: 12/552,977

(22) Filed: Sep. 2, 2009

(30) Foreign Application Priority Data
Sep. 5, 2008 (FR) 0804865

(51) Int. Cl. H04N 5/64; G09G 5/00

(52) U.S. Cl. 348/836; 345/205; 348/E05.128

(57) ABSTRACT

The display device (10) comprises a substantially parallelepipedal flat case, having a front face (14), a rear face (18) and side faces forming a peripheral edge. The case accommodates a display screen adapted to produce an image as a pixel array, and means for processing data and driving the display screen. The case comprises a housing (50) and a front part (96, 106) detachably assembled together through a mechanical fastening lock (84). The front part comprises a front glass (106) and a support part (96). The front glass extends from side to side over the support part and is non-detachably attached to the latter, and the support part comprises a central window and elements (102) for engaging the fastening lock (84).

The present invention relates to a digital image display device, i.e. a stand-alone device for displaying digital photographs on a screen.

Such a display device or “digital frame” is described, for example, in WO 2007/015009 A2 (Seydoux) or in US2008/0204359 A1 (Perception digital Ltd.). Devices of this sort are consumer goods that can be bought or offered just like a frame for receiving a traditional photograph, being externally identical thereto and intended to be used in the same way, for example laid on a table, a fireplace mantel, a piano, etc.

The above-mentioned WO 2007/015009 A2 describes such a digital frame designed, among other things, in such a way to soften the technological character of the product (unlike some sophisticated appliances proposed, for example, as accessories in the field of digital photography), so as to emphasize the similarity of appearance and use with the traditional frames and to allow integration thereof in any kind of interior design, as a decorative object far more than as a technological object.

As regards aesthetic appearance, the current trend is the absence of any visible assembling means (screw housing, etc.), not only on the front part and the sides, but also on the back of the product. However, from the technical view, it may be desirable that the product can be dismantled, for example for a reworking thereof, i.e. a punctual correction, should a defect be detected during the manufacturing.

The stylistic trend also goes toward slimmer cases, whose reduced thickness and small available room bring about technical design difficulties to accommodate all the necessary components therein without needing compromise with the requirements of the designer.

Another important factor regarding the aesthetic appearance is the frame's power cable, which often tends to protrude from the side. Even when the cable is hidden behind the frame, the fact of handling the frame, notably to change from “portrait” to “landscape” orientation or the reverse, often has the effect to move the cable, with moreover the risk to put back the frame down on the cable, which would render the unit unstable.

Another difficulty, which is more technical, relates to the mounting of the display screen, as a component, inside the frame.

From the point of view of the frame manufacturer, taking into account notably the great demand for display screens, it may be advisable to supply from various sources. Unfortunately, from one provider to another, the display screens are not all mechanically compatible with each other, so that the different external dimensions and the adjustment of the visible surface in position pose problems to the frame manufacturer to adapt those different components to the frame's parts that support the display screen. For that purpose, it would be desirable to have a relatively flexible system making it possible to receive display screen components coming from different providers without having to modify any part of the frame, having a possibility to compensate the mechanical differences occurring in the component from one provider to another.

Finally, as regards ergonomic considerations, setting the appliance, selecting the images to display, etc., necessitate to activate a number of functions and to make choices from various menus. In practice, this browsing within the setting menus proves to be rather uneasy and user-unfriendly, so that it is important to improve the ergonomics of the frame when several settings have to be made.

The invention proposes a digital image display device or “digital frame” permitting to achieve all the above objectives.

This display device is of the general type described in the above-mentioned WO 2007/015009 A2, i.e. it comprises: a substantially parallelepipedal flat case, having a front face, a rear face and side faces forming a peripheral edge; accommodated within the case, a display screen adapted to produce an image as a pixel array; and means for processing data and driving the display screen. According to a feature of the present invention, the case comprises a housing and a front part detachably assembled together through a mechanical fastening lock, and the front part comprises a front glass and a support part. The front glass extends from side to side over the support part and is non-detachably attached to it, and the support part comprises a central window and elements for engagement of the fastening lock.

According to various preferential subsidiary features:
the lock comprises a slide mobile between a lock position and an open position;
the lock comprises a control member which is accessible through a trap made in a wall of the case;
the display device further comprises support means for mounting the display screen in the case, said support means comprising a elastomeric separator surrounding the peripheral rim of the display screen;
the display screen is offset with respect to the median axis of the case, so as to provide a gap, laterally inside the case, on the side opposite to the offset side, and the offset display screen comprises an active surface having a display area centered with respect to the median axis of the case, and an adjacent unused area located on the offset side of the display screen;
in particular, in the latter case, when the display device comprises a connector coupled to the processor means and having a receptacle adapted to receive a removable digital data medium pluggable from the outside of the case according to a plug-in direction, the connector can be accommodated in the room defined by said gap formed on the side opposite to the offset side of the display screen;
the display device comprises a holding prop protruding from the case's rear face, having a fulcrum-forming distal end, said fulcrum defining with one side of the case's edge a support polygon allowing the case to stay in a stand-up position when the display device is laid on a support surface, and the prop is a rigid rod extending perpendicular to the case's rear face and fastened to the latter at an anchoring point located in a corner region of the case;
in particular, in the latter case, when the display device comprises a connector coupled to the processor means and having a receptacle adapted to receive a removable digital data medium pluggable from the outside of the case, the connector is placed near the anchoring point of the rigid rod, in said corner region of the case;
the rigid rod of the prop may be hollow and have a power lead running axially right through it, wherein the lead exits from the distal end of the rod;
the display device further comprises, on the case's rear face, control buttons arranged according to a configuration homologous to corresponding areas on a graphic interface shown on the display screen, on the side of the case's front face.

An embodiment of the digital frame according to the invention will now be described with reference to the appended drawings, in which the same numerical references are used from one figure to another to denote elements that are identical or functionally similar.

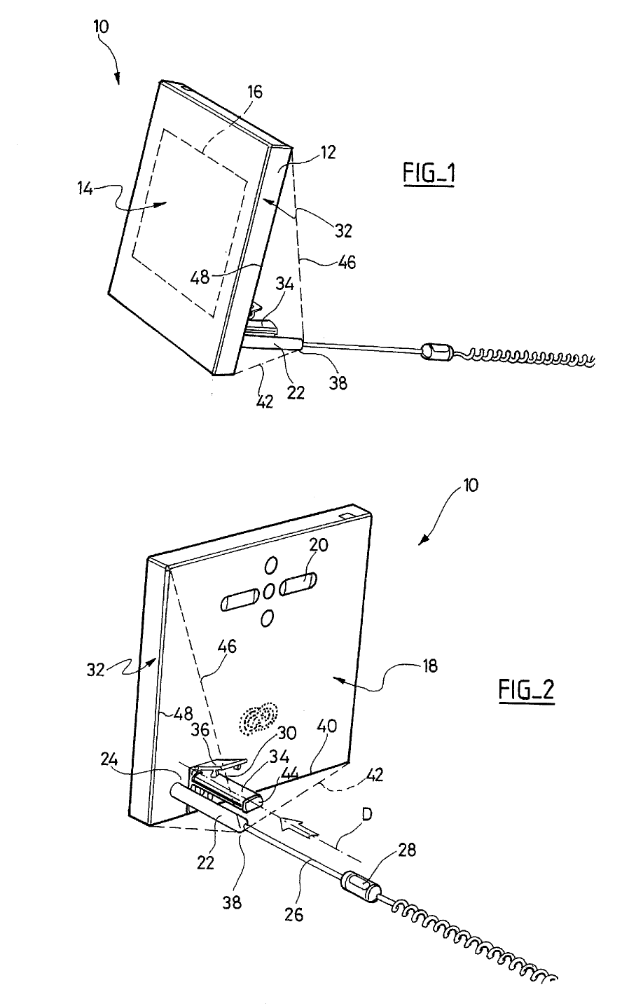

FIG. 1 is a three-quarter front perspective view of a digital frame according to the invention;

FIG. 2 is a three-quarter rear perspective view of the digital frame of FIG. 1;

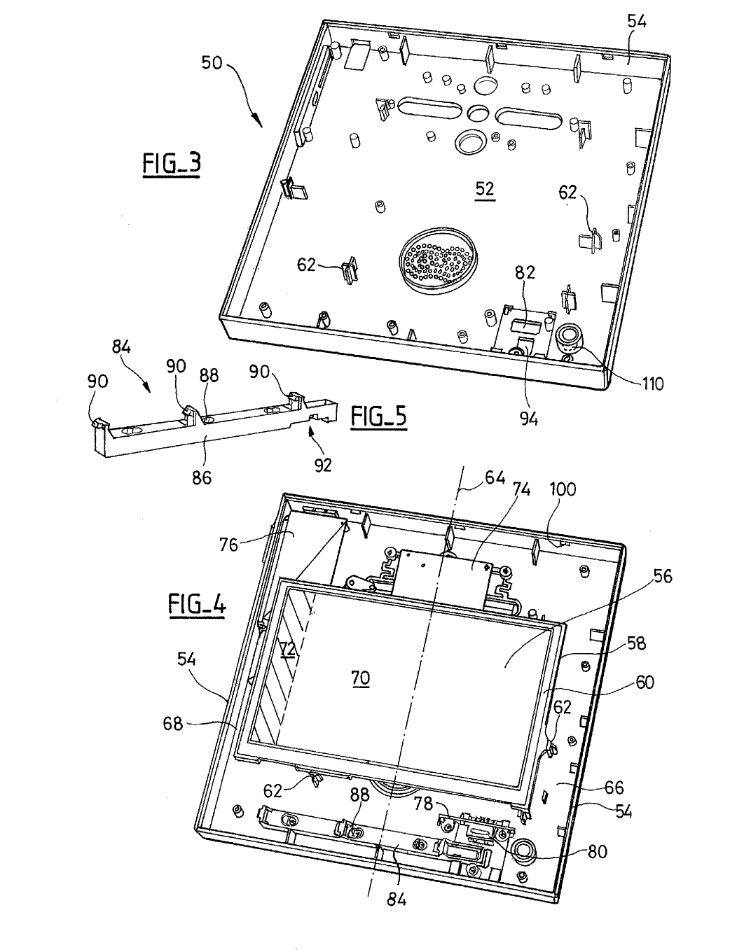

FIG. 3 illustrates, in isolation, the housing into which the successive elements making up the frame according to the invention will be later arranged during the manufacturing process;

FIG. 4 illustrates the same housing, after a number of components have been placed therein, notably the display screen, the connector and the closing lock;

FIG. 5 illustrates, in isolation, the closing lock shown in context in FIG. 4;

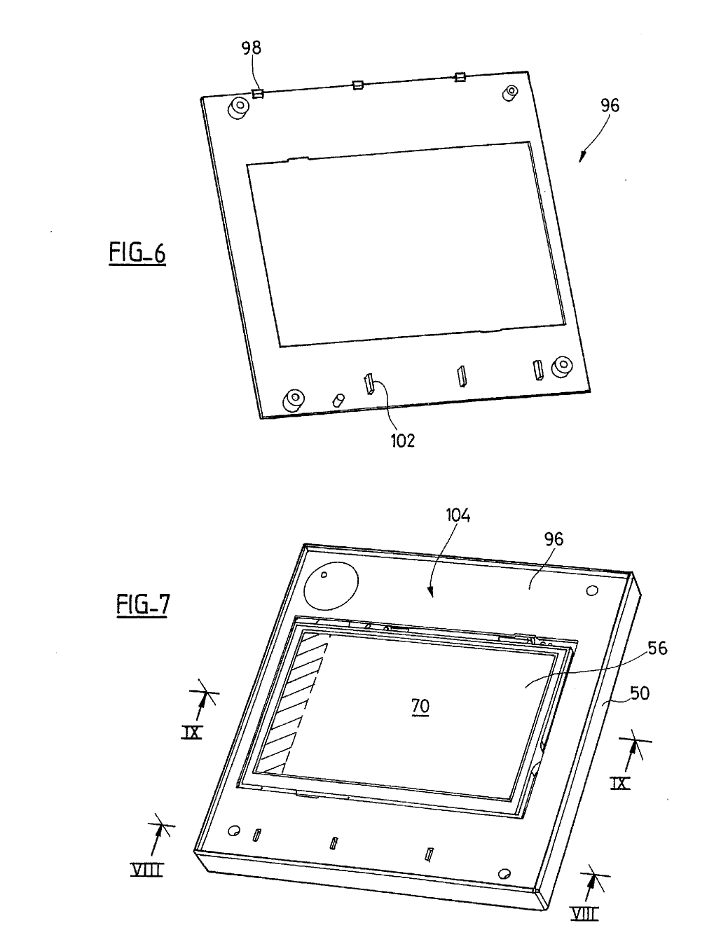

FIG. 6 illustrates a back view of the frame's front part, taken in isolation, before the mounting thereof onto the housing;

FIG. 7 is homologous to FIG. 4, after the front part has been placed and before the front glass has been stuck;

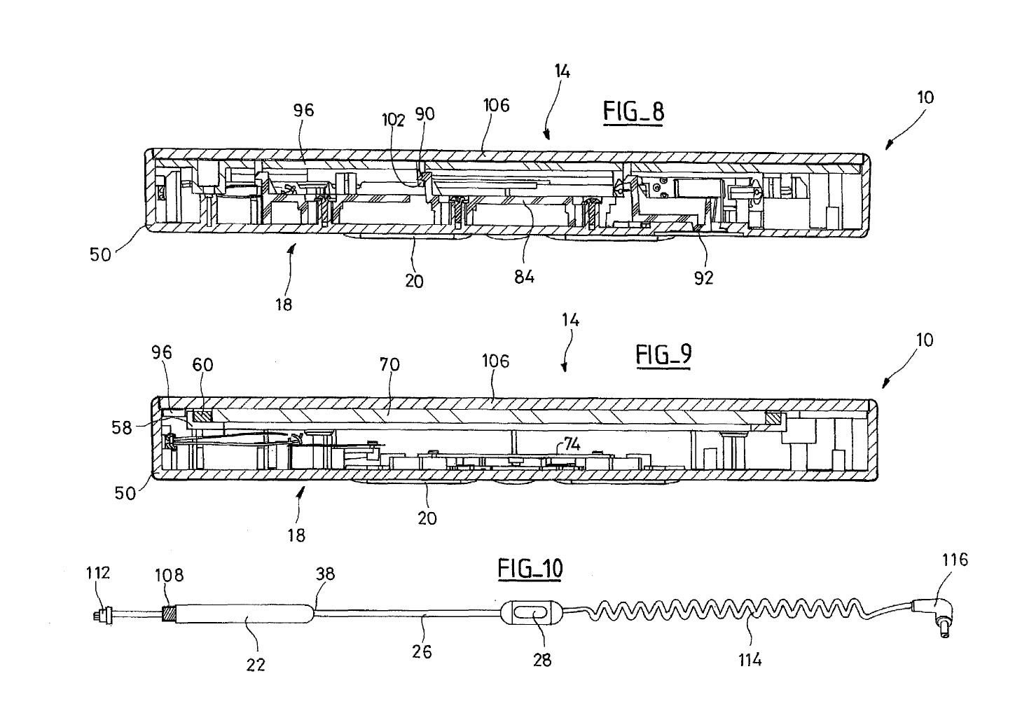

FIGS. 8 and 9 are cross-sectional elevation view, taken respectively along the lines VIII-VIII and IX-IX in FIG. 7, of the frame according to the invention, after the final assembling, with the front glass in place;

FIG. 10 is a view of the power cable and the holding prop of the frame, taken in isolation, these elements being also visible in context in FIGS. 1 and 2;

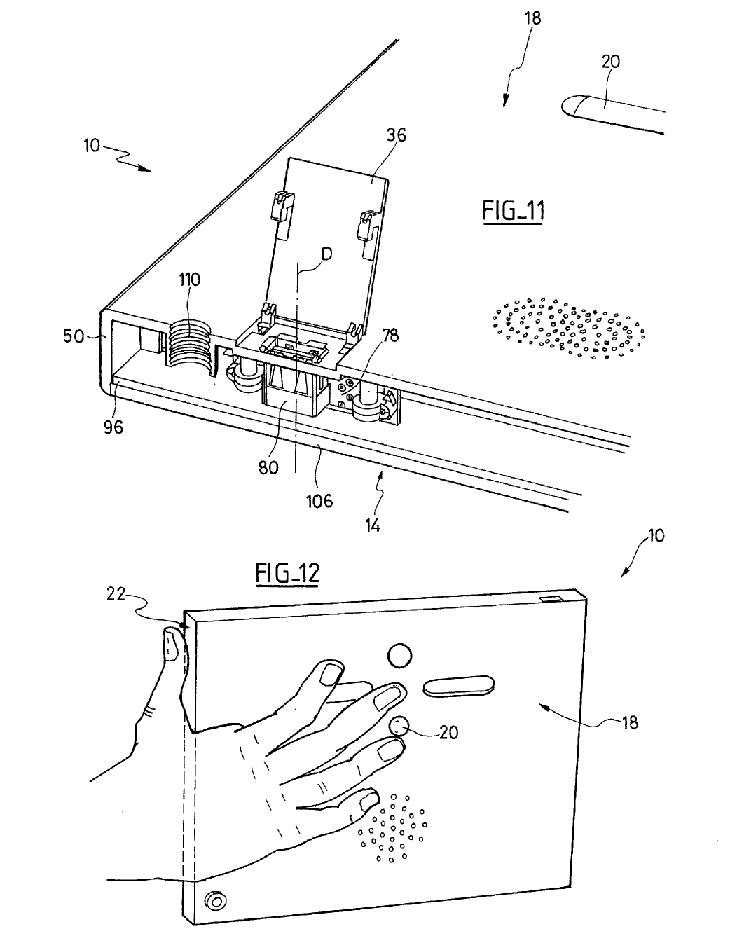

FIG. 11 is a cross-sectional perspective view of a detail of the frame in the support prop and USE connector region;

FIG. 12 shows the configuration of the control buttons, illustrating how the frame setting interface ergonomics is optimized.

FIGS. 1 and 2 show a digital image display device according to the invention in its general external configuration.

The digital image display device or “digital frame” 10 comprises a flat parallelepipedal case 12, having a plane front face 14 through which can be seen the image 16 produced by the digital display screen.

In a particularly aesthetic manner, the front face 14 may be made of a plane glass extending from one side of the digital frame to the other, wherein such front face is stuck and lets no fastening means appear. As the displayable image 16 is smaller than the front glass which extends from side to side, this glass may be advantageously made of a semi-transparent material, such as for example a mirror without silvering, so as to let appear the digital image 16 only when the display is active and emits light, the front face looking like a simple mirror in the absence of light activation of the display screen located under the semi-transparent glass.

The rear face 18 of the frame, visible in FIG. 2, carries control buttons 20, for example to adjust various parameters such as the slideshow speed, the transition effect mode, the automatic off function, etc.

When the frame is laid on a support (table, etc.), a holding prop 22 is provided, for example a cylindrical rod fastened or nested in a lower corner region 24 of the rear face, so as to hold the frame's case in a slightly inclined stand-up position.

Furthermore, a power lead 26 is provided, which is equipped with a switch 28 and connected to the frame's electronic circuits. Advantageously, the power lead 26 runs axially right through the holding prop 22, the lead exiting through the distal end of the prop 22 (this aspect will be more fully explained with reference to the description of FIG. 10).

Moreover, the frame is provided with a connector, for example of the USB type, for plugging a removable data medium of the “USB key” type, or connecting a cable for linking to a computer, an image-storage hard disk drive, etc., so as to download into the frame files containing image data to be displayed. Incidentally, it will be noted that the reference to a USB-type port is not limitative and is given only by way of example, and that the same is true whatever the connection standard: Compact Flash, SD card, FireWire, etc.

With the conventional digital frames, this connector is generally placed on the peripheral edge 32 and forms a protruding add-on element that is particularly visible and very unaesthetic, all the more in the case of an elongated and prominent USB key, especially if the color of the latter is contrasting with that of the frame. On the other hand, in the case of the frame according to the invention, this connector 30 is placed in the lower angle region 24, which is the region where the prop is located, and further the plug-in direction D is perpendicular to the surface of the rear face 18. When the connector 30 is not in use, a closing flap 36 serves to hide the trap in which the USB-connector receptacle is located. As a result of this configuration in which the USB connector is located near the prop, preferably slightly higher than the latter, the USB key 34, after being plugged in, is quite invisible from the outside, whatever the position of the frame, either horizontal (as illustrated in FIGS. 1 and 2) or vertical (i.e. rotated by 90° with respect to that illustrated in the Figures, with the prop still resting on the support surface).

When the user wishes to use the connector, he/she opens the flap 36 and plugs in the USB key 34 according to the direction D perpendicular to the rear face 18. In the illustrated position (horizontal position of the frame), the distal end 38 of the prop 22 and the coin 40 of the rear face resting on the support surface define together a support polygon 42, such that the distal end of the USB key 44, whatever the key model used, does not extend beyond this polygon (triangle) 42. The same is true when the frame is rotated one-quarter of a turn (vertical position), the polygon 46 being then defined by the distal end 38 of the prop 22 and the coin 48 of the peripheral edge 32. This configuration, with a long-enough prop 22 and a slight inclination of the frame, allows accommodation of the USB key in a “dead area” of the rear face, which is anyway not used, so that the key is never cumbersome, whatever the place where the frame is laid, on a table, against a wall, etc. Moreover, when we stand in front of the frame, or slightly on the side thereof, due to the position of the connector 30 near the prop 22 and slightly toward the inside of the frame, the USB key is not visible, whatever the frame is in vertical position or in horizontal position, the latter position being a configuration particularly advantageous from the aesthetic point of view—unlike the conventional digital frames having a connector located on the edge, where the USB key protrudes from the frame, which is particularly unaesthetic.

The internal structure of the just-described digital frame, and the way it is assembled, will now be described with reference to FIGS. 3-9 and 11.

The basic part shown in isolation in FIG. 3 is a housing 50 intended to receive the different components of the frame. This housing comprises a bottom wall 52 corresponding to the rear face 18 of the frame, and side walls 54 forming the edge 32 of the latter.

As illustrated in FIG. 4, the housing 50 receives a display screen 56, for example of the LCD-type. One of the difficulties lies in the fact that the display screens produced by different providers are not all mechanically compatible with each other and may slightly vary as for their external dimensions and the centering of the display area. In order to facilitate the integration of display screens coming from different sources, the invention provides for mounting the display screen 56 on the housing 50 by means of a peripheral rigid frame 58, with intercalation of a flexible separator 60. The separator 60 is, for example, made of an elastomeric material, such as a silicone, and the dimensions thereof are adapted to each type of display screen produced by a given provider. Given that the time necessary to manufacture and develop tools for the manufacturing of elastomeric parts is very short and the manufacturing costs of these parts are not very high (in comparison with parts made of rigid plastic material), it becomes easy to adapt the digital frame according to the external dimensions of a display screen coming from this or that supplying source. Moreover, the deformability of the separator 60 makes it possible to easily fill the clearances liable to affect the display screens. As for it, the external frame 58 rests on vertical legs 62 molded in the bottom wall 52 of the housing 50 and protruding from the latter, so as to ensure the height-position adjustment of the display screen carried by the elastomeric separator 60, to a level at which this display screen 70 substantially makes flush with the peripheral rim of the side wall 54 (to within the thickness of the front glass, as can be seen more precisely in the cross-sectional views of FIGS. 8 and 9).

Another difficulty due to the nature of the commonly used LCD screens lies in the fact that they are very often 16:9-format and thus relatively elongated screens. These long screens may prove problematic regarding the placement of components, such as USB connectors, which take up most of the thickness of a frame when the latter is very flat. On the other hand, the photos shown on a digital frame are rarely in the 16:9 format or the like, but rather in a less elongated format, with proportions such as 4:3 or 3:2.

According to a feature of the present invention, in order to take this problem into account, the display 56 is sidewise offset with respect to the median axis 64 of the housing 50 (and thus of the frame it-self). Thus, it remains with respect to the side wall 54 a gap 66 which is larger than that at the opposite side (gap 68). On the other hand, only a portion of the display screen's surface is used to show the digital image, this surface being divided into, on the one hand, a useful display area 70 centered with respect to the median axis 64 and, on the other hand, an offset, not-used, end area 72, located on the side of the narrowest gap 68. Of course, the display screen will be driven so that the displayed image is offset with respect to the whole displayable surface of the display screen 56, bus centered with respect to the useful display area 70, and thus centered for the user, with respect to the median axis 64 of the frame.

In a particular embodiment (not illustrated), the room located on the side of the wide gap 66, which remains free due to the offset of the display screen 56, is used to accommodate the USB connector, whose integration will not pose any difficulty even if it takes up almost all the thickness of the frame at this place.

Besides the display screen 56, the housing 50 receives several elements such as printed circuits 74, 76, as well as the small plate 78 carrying the USB connector 80 itself, which is accessible through an orifice 82 made in the bottom wall 52 of the housing (see also FIG. 11). The housing 50 also comprises a mobile lock 84 for detachably securing the front part closing the housing—which part will be described hereinafter with reference to FIGS. 6 and 7. The lock 84 is made of a slide 86 fastened to the housing 50 in such a manner to have only one degree of freedom in translation, between two positions (locked or unlocked). To that end, the slide 86, illustrated in isolation in FIG. 5, comprises oblong holes 88 receiving screws fixed to the bottom of the housing, as well as protruding claws 90 intended to engage with the closing part which will be placed on the housing. On the opposite side, i.e. on the side in contact with the bottom wall 52 of the housing 50, the slide 86 is operated through an opening 94 made in the bottom wall 52 near the opening 82 for access to the USB connector. A notch 92 made in the slide is adapted to the trap for closing the opening 82, which then locks the slide in the closed position.

The closing part 96, illustrated in FIG. 6, comprises, on one of its sides, spigots 98 intended to enter into homologous notches 100 (visible in FIG. 4) made in the housing. On the opposite side, the closing part 96 comprises a receptacle 102 intended to receive the claws 90 of the slide 86 (the reverse configuration being also conceivable, with claws formed on the part 96 and accommodations in the slide 86). Of course, a wide central opening is provided so as not to hide the display screen. FIGS. 7 and 9 illustrate the housing as it is, equipped with its various components, after the closing part 96 has been placed. This mounting operation is made through inserting the spigots 98 into the accommodations 54, bringing the part 96 against the housing and locking these two elements in position through sliding the lock 84, the claws 90 of which enter into the accommodations 102. The sliding of the lock 84 is made through the opening 94, by means of a protruding element for handling the locking control system 92.

The exposed front face 104 of the closing part 96 comprises a window whose minimum dimensions correspond to those of the displayable area 70 of the display screen 56. Besides, this face 104 is a plane face on which is stuck a front glass 106 (illustrated in cross-section in FIGS. 8 and 9) extending from one side of the part 96 to the other, and thus from one side of the housing 50 to the other. This glass 106 is detachably fastened to the closing part 96, and the mounting means thereof are not visible, for obvious reasons of aesthetic appearance. However, the locking system, which is reversible through the slide 84, does not forbid reopening the case, notably in case where, at the end of the production line, following a quality test, it would be required to open the just-assembled case so as to proceed to a reworking (correction), which will not pose any particular difficulty inasmuch as the front part, made of the closing part 96 and the front glass 106 stuck thereto, can be easily detached from the housing 50 and thus from the rest of the housing.

FIG. 10 illustrates in more detail how the power cable exits from the digital frame, which need a power supply and thus a power cable for its connection to a mains unit. In order to preserve the general aesthetic appearance of the product, the exit of the cable is provided through the rear face 18, as can be seen in FIG. 2. But, as the holding prop 22 is located on this same face, when the frame is handled and rotated from “portrait” to “landscape” orientation, the risk exists to put back the prop down on the cable, and thus to render the unit unstable. To avoid this drawback, the cable runs right through the prop, which is made in the form of a hollow tube open at its two ends. The proximal end 108 of the prop 22 is nested or screwed into a threaded hole 110 (FIGS. 3 and 11) in the corner region 24, and the respective diameters of the orifice running through the prop and that of the cable are chosen so as to permit the prop to slide and rotate freely with respect to the cable at the time of assembling. In the region of the prop, the cable 26 is a straight cable, ended by a plug 112 to be plugged or welded to an appropriate connector internal to the frame, this connection being made once and for all during the assembling of the frame. Near the prop 22, the cable is straight, but in a more distant region, for example beyond the switch 28, it may be twisted, as illustrated at 114. The distal end of the cable comprises a connector 116 intended to be plugged to an appropriate power unit.

In another embodiment, the prop comprises over its whole length a groove placing the axial orifice receiving the cable in communication with the outside. The cross-sectional dimension of this groove is slightly smaller than the diameter of the cable, so that the latter can escape from the groove once inserted in it. Thus, the prop can rotate around the cable so as to present the same aesthetic appearance whatever the position of the frame (portrait or landscape), and, on the other hand, it can be fully separated from the cable (without needing dissociating the cable from the frame), so as notably to make it possible to hang the frame on a wall.

In this embodiment, the prop is advantageously made of a ferrous material and is secured to the frame by an annular magnet, supplemented with an elastic tore: the prop, attracted by the magnet, can no longer be moved horizontally, and the tore helps to minimize the clearances and provides a sensation of friction during the insertion, in order to provide a sensation of quality. The prop can thus be removed by a simple traction exerted by the user, and can be rotated around its axis so as to position the groove at the desired place and hide it.

Finally, FIG. 12 illustrates another aspect of the invention, which relates to the general improvement of the control button ergonomics.

Conventionally, the settings are made by means of a graphic interface displayed on the screen, on the side of the front face 14. Browsing through this graphic interface is made by means of buttons 20, located on the side of the rear face 18. According to a feature of the present invention, the selection areas of the menus displayed on the screen are displayed at the same level as the corresponding selection buttons arranged in the rear face, so that the user will just have to move the index or middle finger with respect to the button (rear face) corresponding to the area in question displayed at the opposite on the other side of the frame (front face), without having to look at the rear face.

With an arrangement as illustrated (keypad comprising a central button and four up, down, right, left buttons), possibly with some of the buttons having different shapes, the user can easily localize the central button, and then very easily move to the other buttons, in a very intuitive manner and without having to look at the buttons. The various buttons are further positioned in a region of the front face 18 chosen so that, when the user, as illustrated in FIG. 12, put the thumb against the edge 22, the five buttons are naturally placed within the reach of the index or middle finger. The user needs not to touch the front face of the frame (unlike the touch screens, for example) and thus does not leave any visible fingerprint on the front glass, as only the thumb rests on the frame's edge.

1. A digital image display device (10), comprising:
a substantially parallelepipedal flat case, having a front face (14), a rear face (18) and side faces forming a peripheral edge (32);
accommodated within the case, a display screen (56) adapted to produce an image as a pixel array; and
means for processing data and driving the display screen;
the display device being characterized in that:
the case comprises a housing (50) and a front part (96, 106) detachably assembled together through a mechanical (90, 102) fastening lock (84), and
the front part comprises a front glass (106) and a support part (96), wherein the front glass extends from side to side over the support part and is non-detachably attached to it, and the support part comprises a central window and elements (102) for engagement of the fastening lock (84).

2. The display device according to claim 1, in which the lock (84) comprises a slide (86) mobile between a lock position and an open position.

3. The display device according to claim 1, in which the lock (84) comprises a control member (92) which is accessible through a trap (94) made in a wall of the case.

4. The display device according to claim 1, further comprising support means for mounting the display screen (56) in the case, said support means comprising a elastomeric separator (60) surrounding the peripheral rim of the display screen.

5. The display device according to claim 1, in which:
the display screen (56) is offset with respect to the median axis (64) of the case, so as to provide a gap (66), laterally inside the case, on the side opposite to the offset side, and
the offset display screen (56) comprises an active surface having a display area (70) centered with respect to the median axis (64) of the case, and an adjacent unused area (72) located on the offset side of the display screen.

6. The display device according to claim 5, in which:
the display device comprises a connector (30) coupled to the processor means and having a receptacle adapted to receive a removable digital data medium (34) pluggable from the outside of the case according to a plug-in direction (D), and
the connector is accommodated in the room defined by said gap (66) formed on the side opposite to the offset side of the display screen.

7. The display device according to claim 1, in which:
the display device comprises a holding prop (22) protruding from the case's rear face, having a fulcrum-forming distal end (38), said fulcrum defining with one side (40) of the case's edge a support polygon (42) allowing the case to stay in a stand-up position when the display device is laid on a support surface, and
the prop (22) is a rigid rod extending perpendicular to the case's rear face and fastened to the latter at an anchoring point (110) located in a corner region (24) of the case.

8. The display device according to claim 7, in which:
the display device comprises a connector (30) coupled to the processor means and having a receptacle adapted to receive a removable digital data medium (34) pluggable from the outside of the case, and
the connector (30) is placed near the anchoring point (110) of the rigid rod, in said corner region (24) of the case.

9. The display device according to claim 8, in which the rigid rod of the prop (22) is hollow and has a power lead (26) running axially right through it, wherein the lead exits from the distal end (38) of the rod.

10. The display device according to claim 1, further comprising, on the case's rear face (18), control buttons (20) arranged according to a configuration homologous to corresponding areas of a graphic interface shown on the display, on the side of the case's front face (14).
